(19) United States
(12) Patent Application Publication
(10) Pub. No.: US 2007/0243032 A1
(43) Pub. Date: Oct. 18, 2007

(54) Nose-piece apparatus for a drilling system and method of use

(76) Inventor: Kenneth D. Harper, O'Fallon, MO (US)

Correspondence Address: WILDMAN HARROLD ALLEN & DIXON LLP;AND THE BOEING COMPANY, 225 W. WACKER DR., CHICAGO, IL, 60606, US

(21) Appl. No.: 11/405,914

(22) Filed: Apr. 17, 2006

(51) Int. Cl. B23B 47/28

(52) U.S. Cl. 408/115 B

(57) ABSTRACT

The invention discloses differing embodiments of nose-piece apparatus for drilling, and methods for their use. In one embodiment, a nose-piece apparatus for a drilling system may comprise a body defined by a first hole, a bushing at least partially disposed in the first hole, and a pin attached to the body. A surface of the bushing may be defined by a notch. A portion of the pin may be disposed against the notch on one side of the bushing to substantially prevent the bushing from moving within the first hole.

### BACKGROUND OF THE INVENTION

There are a variety of nose-piece apparatus known in the art for drilling systems. In some of the nose-piece apparatus, a bushing is held within a body through the use of screws. Many of these apparatus experience one or more problems, such as the bushing rotating, moving, or falling out of the body when the screws loosen, angular forces being exerted by the screws on one or more sides of the bushing thereby causing misalignment, and other additional problems.

A nose-piece apparatus, and method for its use, is needed which may solve one or more problems in one or more of the existing drilling systems.

### SUMMARY OF THE INVENTION

In one aspect of the invention, a nose-piece apparatus for a drilling system comprises a body defined by a first hole, a bushing at least partially disposed in the first hole, and a pin attached to the body. A surface of the bushing is defined by a notch, and at least a portion of the pin is disposed against the notch on one side of the bushing to substantially prevent the bushing from moving within the first hole.

In another aspect of the invention, a method is disclosed for restraining a bushing within a body in a drilling system. The method comprises disposing a bushing at least partially within a first hole of a body, attaching a pin to the body, and abutting at least a portion of the pin against a notch defined in the bushing.

In a further aspect of the invention, a nose-piece apparatus for a drilling system comprises a body defined by first and second holes, a bushing at least partially disposed in the first hole, and a pin extending at least partially through the second hole. At least a portion of the first and second holes intersect. An outer surface of the bushing is defined by a notch which only extends through a portion of the outer surface. At least a portion of the pin is disposed against the notch to substantially prevent the bushing from moving within the first hole.

These and other features, aspects and advantages of the invention will become better understood with reference to the following drawings, description and claims.

### BRIEF DESCRIPTION OF THE DRAWINGS

FIG. 1 is a perspective view of one embodiment of a nose-piece apparatus under the invention;

FIG. 2 is a cut-away, cross-sectional, side view along line 2-2 of the embodiment shown in FIG. 1;

FIG. 3 is a cut-away, cross-sectional, top view along 3-3 of the embodiment shown in FIG. 2; and

FIG. 4 depicts an embodiment of a method under the invention for restraining a bushing within a body in a drilling system.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

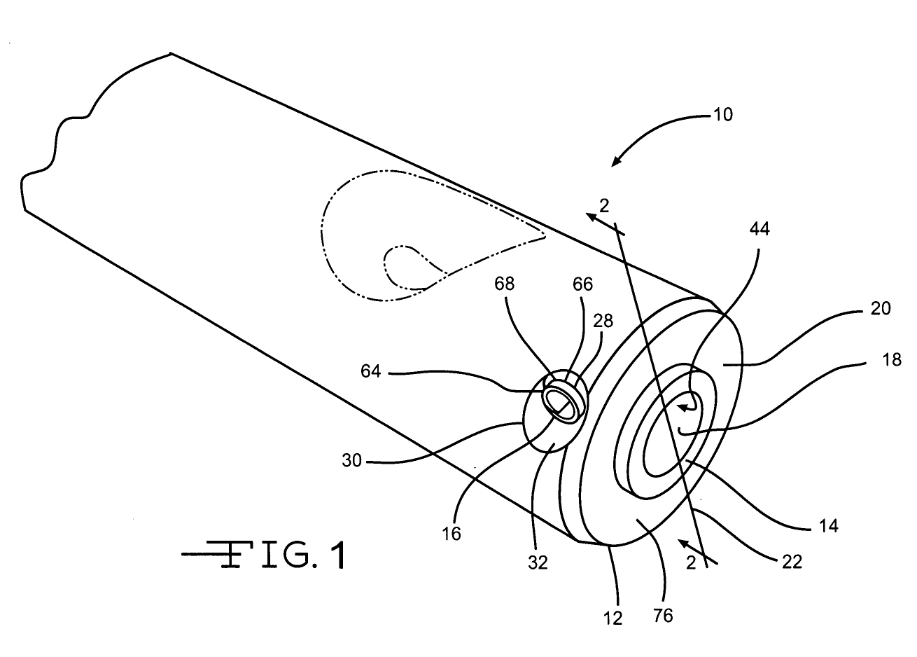

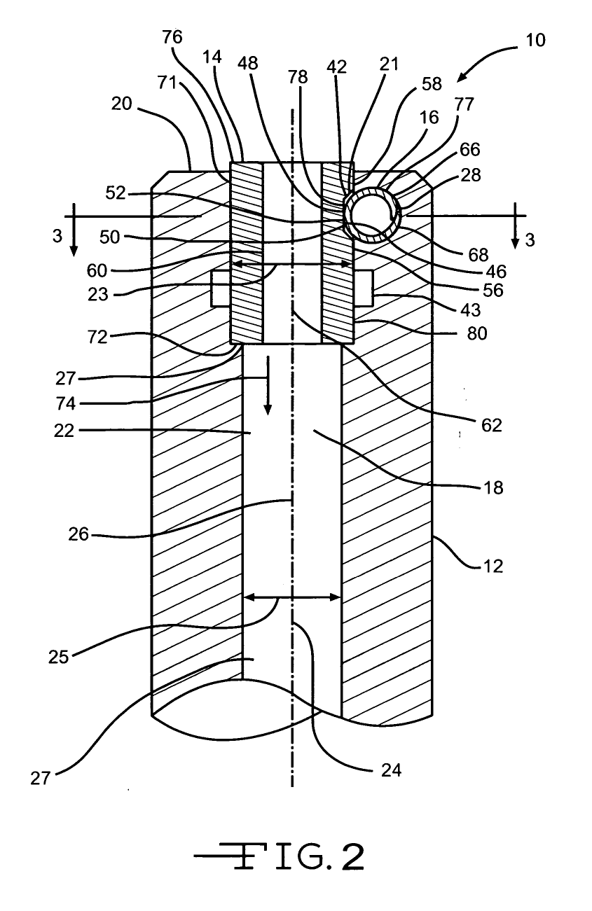

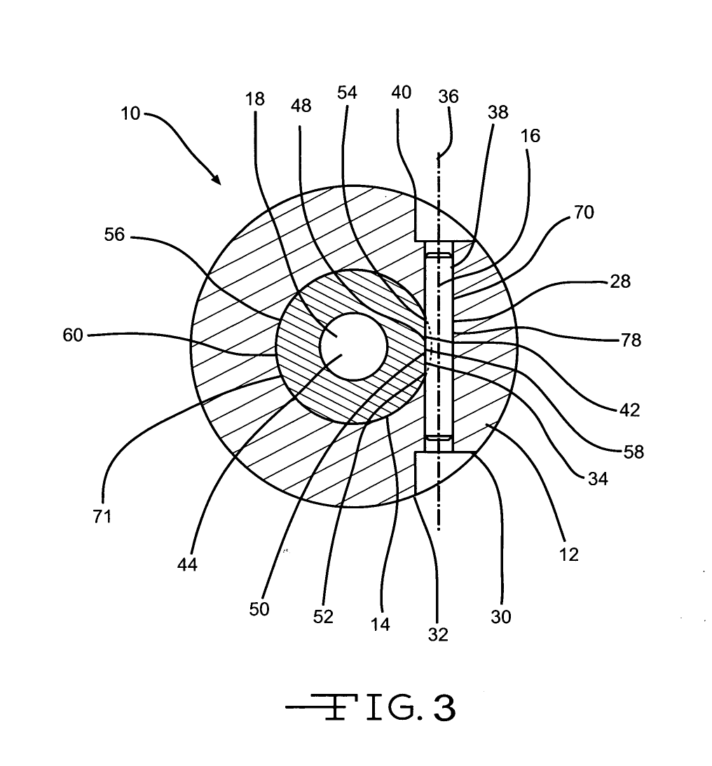

In one embodiment of the invention, as shown in FIGS. 1, 2, and 3, a nose-piece apparatus 10 for a drilling system is provided. The nose-piece apparatus 10 may be used to guide a drill (not shown) during a drilling process. The nose-piece apparatus 10 may be used in conjunction with an end effector for robotic drilling. In other embodiments, the nose-piece apparatus 10 may be used in any type of drilling process known in the art, including both automated and manual drilling processes. The nose-piece apparatus 10 may comprise a body 12, a bushing 14, and a pin 16.

The body 12 may comprise a substantially cylindrical shape. The body 12 may be defined by a substantially cylindrical, internal hole 18 extending from a top portion 20 of the body 12 through a length-wise cross-section 22 of the body 12. The hole 18 may be aligned along a center-line 24 of the body 12, and may extend along the entire length 26 of the body 12. The top portion 21 of the hole 18 may have a larger diameter 23 than the diameter 25 of the lower portion 27 of the hole 18. In other embodiments, the body 12 and the hole 18 may be of any type, shape, size, orientation, and/or configuration. The body 12 may be made of steel. In other embodiments, the body 12 may be made of any known material.

The body 12 may be defined by a second hole 28. The second hole 28 may extend from an outer surface 30 at one side 32 of the body 12, through a widthwise cross-section 34 of the body 12 in a direction 36 substantially perpendicular to and offset from center-line 24 and hole 18, through outer surface 38 at another side 40 of the body 12. A portion 42 of holes 18 and 28 may intersect. The second hole 28 may be substantially cylindrical. In other embodiments, the second hole 28 may be U-shaped and/or of any type, shape, size, orientation, and/or configuration. A lubrication cavity 43, adapted to lubricate internal bushings, may be contained within the body 12 adjacent the top portion 21 of the hole 18.

The bushing 14 may comprise a generally cylindrical shape, may be made of carbide, and may have a generally cylindrical hollow interior cavity 44 adapted to allow insertion and/or attachment of a drill bit (not shown). One or more surfaces 46 of the bushing 14 may be defined by a notch 48. The notch 48 may comprise a flat surface 50 extending from one side 52 through another side 54 of the bushing's outer surface 56. The notch 48 may only extend through a portion 58 of the bushing's outer surface 56 and may not extend through another portion 60 of the bushing's outer surface 56. The notch 48 may extend in a substantially parallel direction with respect to a center-line 62 of the bushing 14, and may be offset with respect to the center-line 62. In other embodiments, the bushing 14, interior cavity 44, and/or notch 48 may be of any type, size, shape, orientation, configuration, and/or material.

The pin 16 may comprise a generally cylindrical shape made of steel. The pin 16 may be a split-pin (or roll-pin), as known in the art, having a hollow interior 64 and a resilient outer surface 66 capable of contracting and expanding upon the exertion of force upon the outer surface 66. The pin 16 may have a diameter 68 substantially in the range of 1/16 of an inch to ¼ of an inch and a length 70 substantially in the range of ¼ of an inch to ¾ of an inch. In other embodiments, the pin 16 may be of any type, size, shape, orientation, configuration, and/or material.

In operation, the bushing 14 may be at least partially disposed in the hole 18 within the body 12. The diameter 71 of the bushing 14 may be slightly less than the top portion diameter 23 of the hole 18, and slightly greater than the lower portion diameter 25 of the hole 18. In such manner, the bushing 14 may be inserted into the top portion 21 of the hole 18. Once inserted within the hole 18, the bottom portion 72 of the bushing 14 may be abutted against the lower portion 27 of the hole 18 to restrain the bushing 14 from traversing farther in direction 74.

After insertion, a top portion 76 of the bushing 14 may extend past the top portion 20 of the body 12. The bushing 14 may be rotated within the hole 18 using the exposed top portion 76 of the bushing in order to align the notch 48 with the second hole 28. Pin 16 may be at least partially extended through aligned second hole 28 in the body 12 and notch 48 in the bushing 14 in order to secure the bushing 14 within the hole 18 in body 12. The diameter 68 of the pin 16 may be slightly larger than the diameter 77 of the second hole 28. The outer surface 66 of the pin 16 may be forced to contract when the pin 16 is inserted into the second hole 28, and may subsequently expand after insertion to fixedly attach the pin 16 within the second hole 28 of the body 12. In such manner, the pin 16 may be attached to the body 12 while at least a portion 78 of the pin 16 may be disposed against the notch 48 on one side 80 of the bushing 14. This alignment may substantially prevent the bushing 14 from moving with the hole 18 of the body 12. For instance, rotational movement of the bushing 14 within the hole 18 may be prevented. The alignment may also prevent the bushing 14 from moving in one or more directions, such as axially, with respect to the body 12. In other embodiments, varying alignments, types, shapes, sizes, orientations, and configurations may be used to attach body 12, bushing 14, and pin 16.

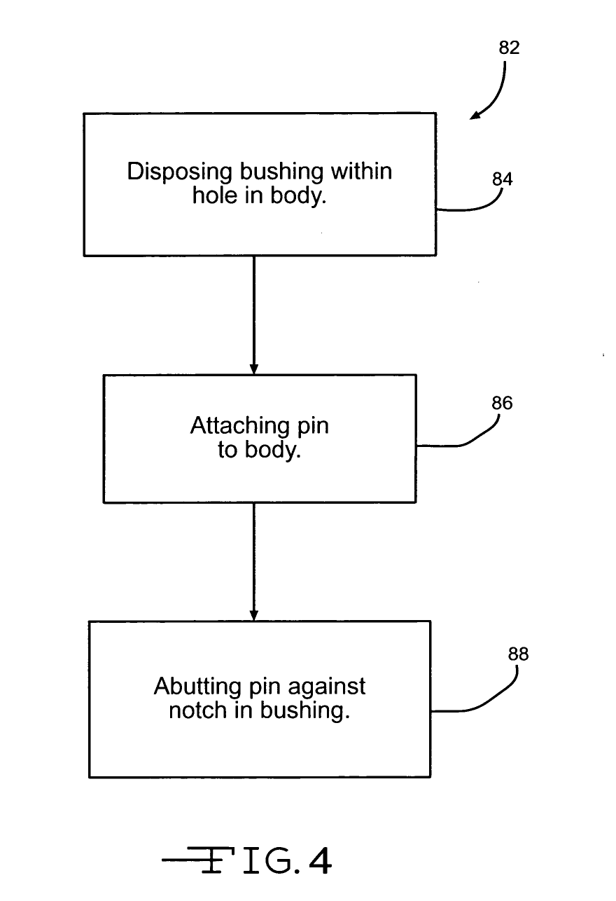

FIG. 4 depicts one embodiment 82 for a method of restraining a bushing within a body in a drilling system. In step 84, a bushing may be disposed at least partially within a first hole of a body. The bushing, body, and first hole may comprise any of the embodiments disclosed herein. In step 86, a pin may be attached to the body. The step of attaching a pin may comprise extending a pin at least partially through a second hole in the body. At least a portion of the second hole in the body may intersect a portion of the first hole of the body. Both the pin and second hole of the body may comprise any of the embodiments disclosed herein. In step 88, at least a portion of the pin may be abutted against a notch defined in the bushing. This may be accomplished by extending the pin at least partially through the second hole in the body at a time when the notch is aligned with the second hole. The notch may comprise any of the embodiments disclosed herein. The abutment of the pin against the notch in the bushing may prevent the bushing from rotating and/or moving in one or more directions with respect to the body.

One or more embodiments of the disclosed nose-piece apparatus and/or methods of the invention may solve one or more problems in existing drilling systems and/or methods. The invention may decrease the likelihood that the bushing will rotate within the body, may decrease the likelihood that the bushing will move within or fall out of the body entirely, may decrease the likelihood that the bushing will have angular forces exerted on it, may decrease costs, may decrease failure breakdown, may improve accuracy, may improve timeliness, may improve ease of use, and/or may address other types of problems.

It should be understood, of course, that the foregoing relates to exemplary embodiments of the invention and that modifications may be made without departing from the spirit and scope of the invention as set forth in the following claims.

We claim:

1. A nose-piece apparatus for a drilling system comprising:
a body defined by a first hole;
a bushing at least partially disposed in said first hole, wherein a surface of said bushing is defined by a notch; and
a pin attached to said body, wherein at least a portion of said pin is disposed against said notch on one side of said bushing to substantially prevent said bushing from moving within said first hole.

2. The nose-piece apparatus of claim 1 wherein said nose-piece apparatus is adapted to attach to an end-effector.

3. The nose-piece apparatus of claim 1 wherein said body substantially comprises a cylinder.

4. The nose-piece apparatus of claim 1 wherein said body is made of steel.

5. The nose-piece apparatus of claim 1 wherein said body is further defined by a second hole and at least a portion of said first and second holes intersect.

6. The nose-piece apparatus of claim 1 wherein said first hole substantially extends through a center-line of said body.

7. The nose-piece apparatus of claim 1 wherein said first hole comprises a substantially cylindrical hole extending along a length of said body.

8. The nose-piece apparatus of claim 1 wherein said bushing is made of carbide.

9. The nose-piece apparatus of claim 1 wherein said bushing and said first hole are substantially cylindrical.

10. The nose-piece apparatus of claim 1 wherein an outer surface of said bushing is defined by said notch.

11. The nose-piece apparatus of claim 10 wherein said notch only extends through a portion of said outer surface.

12. The nose-piece apparatus of claim 11 wherein said notch comprises a substantially flat surface.

13. The nose-piece apparatus of claim 12 wherein said substantially flat surface extends substantially parallel to a center-line of said bushing.

14. The nose-piece apparatus of claim 1 wherein said pin is made of steel.

15. The nose-piece apparatus of claim 1 wherein said pin is a split-pin.

16. The nose-piece apparatus of claim 1 wherein said pin has a diameter substantially in the range of 1/16 of an inch to ¼ of an inch and a length of substantially in the range of ¼ of an inch to ¾ of an inch.

17. The nose-piece apparatus of claim 5 wherein said pin extends at least partially through said second hole.

18. A method of restraining a bushing within a body in a drilling system, the method comprising:
disposing a bushing at least partially within a first hole of a body;
attaching a pin to said body; and
abutting at least a portion of said pin against a notch defined in said bushing.

19. The method of claim 18 wherein said first hole is substantially aligned with a center-line of said body.

20. The method of claim 18 wherein the step of attaching a pin to said body comprises extending said pin at least partially through a second hole in said body.

21. The method of claim 20 wherein said second hole in said body is off-center with respect to a center-line of said body.

22. The method of claim 20 wherein at least a portion of said first and second holes intersect.

23. The method of claim 18 wherein said pin comprises a split-pin.

24. The method of claim 18 wherein said method prevents said bushing from rotating within said body.

25. The method of claim 18 wherein said method prevents said bushing from moving in at least one direction with respect to said body.

26. The method of claim 18 wherein said notch is defined in an outer surface of said bushing.

27. The method of claim 26 wherein said notch only extends through a portion of said outer surface.

28. The method of claim 27 wherein said notch comprises a substantially flat surface.

29. The method of claim 28 wherein said substantially flat surface extends substantially parallel to a center-line of said bushing.

30. The method of claim 18 wherein said body comprises a second hole which intersects at least a portion of said first hole, said notch is defined in an outer surface of said bushing, and said notch only extends through a portion of said outer surface of said bushing.

31. The method of claim 30 wherein the step of abutting at least a portion of said pin against a notch defined in said bushing comprises extending said pin at least partially through said second hole.

32. A nose-piece apparatus for a drilling system comprising:
a body defined by first and second holes, wherein at least a portion of said first and second holes intersect;
a bushing at least partially disposed in said first hole, wherein an outer surface of said bushing is defined by a notch which only extends through a portion of said outer surface; and
a pin extending at least partially through said second hole, wherein at least a portion of said pin is disposed against said notch to substantially prevent said bushing from moving within said first hole.

33. The nose-piece apparatus of claim 32 wherein said first and second holes are substantially perpendicular to one another.

34. The nose-piece apparatus of claim 32 wherein both said bushing and said first hole are substantially cylindrical.

35. The nose-piece apparatus of claim 32 wherein said notch is a substantially flat surface.

36. The nose-piece apparatus of claim 32 wherein said second hole is offset from a center-line of said first hole.

37. The nose-piece apparatus of claim 32 wherein said pin is a split-pin.

38. The nose-piece apparatus of claim 32 wherein said pin substantially prevents said bushing from rotating within said first hole and from sliding axially along said first hole.
